(19) United States
(12) Patent Application Publication
(10) Pub. No.: US 2021/0286631 A1
(43) Pub. Date: Sep. 16, 2021

(54) METHOD AND DEVICE FOR CONFIGURING A SYSTEM ARCHITECTURE OF AN AUTONOMOUS VEHICLE

(71) Applicants: Volkswagen Aktiengesellschaft, Wolfsburg (DE); Argo Al GmbH, Munich (DE)

(72) Inventors: Tobias Kain, Oberndorf/Melk (AT); Julian-Steffen Müller, Hanover (DE); Maximilian Wesche, Edemissen (DE); Hendrik Decke, Braunschweig (DE); Philipp Mundhenk, Höhekirchen-Siegertsbrunn (DE)

(21) Appl. No.: 17/194,095

(22) Filed: Mar. 5, 2021

(30) Foreign Application Priority Data
Mar. 12, 2020 (EP) 20162626.4

(51) Int. Cl. G06F 9/445; B60W 40/02; G06K 9/62

(52) U.S. Cl. CPC G06F 9/44505; B60W 2050/0083; G06K 9/6262; B60W 40/02

(57) ABSTRACT

A system architecture of an autonomous vehicle, wherein the system architecture includes a plurality of application instances and nodes. The application instances are distributed and executed on the computation nodes according to a configuration, wherein measured sensor data of at least one sensor is input to at least part of the application instances, and wherein at least part of the application instances creates and provides control signals for controlling the vehicle. At least one context information of a prevailing context is gathered, and wherein the configuration is adapted according to the at least one gathered context information.

### RELATED APPLICATIONS

The present application claims priority under 35 U.S.C. § 119(b) to European Pat. App. No. EP 20 162 626.4 filed Mar. 12, 2020, the contents of which is incorporated by reference in its entirety herein.

### FIELD OF TECHNOLOGY

The present disclosure relates to a method and a device for configuring a system architecture of an autonomous vehicle.

### BACKGROUND

Present day vehicles are equipped with various driver assistance systems that support the driver while operating the vehicle. Assistance function include, for example, maintaining a distance to a preceding vehicle, autonomous parking, or switching lanes on highways. Although these functions are highly reliable and well tested, the driver is still constrained to monitor their behavior and take over the control, if required.

Fully autonomous vehicles do not allow such take over actions, hence the system responsible for operating the car has to be designed in a fail-operational manner, wherein the system would need to handle faults autonomously.

Although handling faults by performing an emergency stop is feasible, such behavior is not desirable since this will cause customer satisfaction to decline. On the other hand, increasing the fault-acceptance rate might cause vehicles to operate unintentionally, leading to a loss of customer confidence. Therefore, solutions to handle these situations are required.

### SUMMARY

The present disclosure is based on the technical problem of developing a method and a device for configuring a system architecture of an autonomous vehicle, in which the system configuration can be adapted automatically.

Technologies and techniques are disclosed for configuring a system architecture of an autonomous vehicle, wherein the system architecture includes a plurality of application instances and a plurality of computation nodes, wherein the application instances are distributed and executed on the computation nodes according to a configuration, wherein measured sensor data of at least one sensor is input to at least part of the application instances, and wherein at least part of the application instances creates and provides control signals for controlling the vehicle, wherein at least one context information of a prevailing context is gathered, and wherein the configuration is adapted according to the at least one gathered context information.

Further, a device is disclosed for configuring a system architecture of an autonomous vehicle is proposed, wherein the system architecture includes a plurality of application instances and a plurality of computation nodes, wherein the application instances are distributed and executed on the computation nodes according to a configuration, wherein measured sensor data of at least one sensor is input to at least part of the application instances, and wherein at least part of the application instances creates and provides control signals for controlling the vehicle; comprising a context gathering device, and a reconfiguration device, wherein the context gathering device is configured to gather at least one context information of a prevailing context, and wherein the reconfiguration device is configured to adapt the configuration according to the at least one gathered context information.

The method and the device allow to automatically reconfigure the system architecture of the autonomous vehicle to adapt to a change of a prevailing situation or environment that the vehicle is experiencing and/or a change occurring in the system architecture (for example, faults of application instances and/or computation nodes). Using techniques disclosed herein, faults and a change of context-related requirements can be automatically handled. This may be achieved by gathering at least one context information of a context in which the vehicle and the system architecture are currently operated in. According to at least one context information that is gathered by the system, the configuration of the system architecture, such as the application instances and the computation nodes, is adapted, which means the configuration is adapted depending on or in consideration of the at least one context information, such that the system architecture is accommodated to the prevailing context. For example, it may be decided how the configuration has to be adapted given the at least one context information with the goal to adapt the configuration in the best possible way to the prevailing context. The at least one context information may be used as input parameter(s) when determining the adapted configuration. For example, the configuration can be adapted by using a set of rules which determines the adaption or the adapted configuration using the at least one context information as input parameter(s).

In some examples, an application instance may be configured as a process that provides a specific functionality and which is executed on at least one computation node. As an example, an application instance can provide one of the following functionalities in the field of autonomous driving: environment perception, localization, navigation, trajectory planer, or prognosis of ego behavior and/or the behavior of objects in the environment of the vehicle etc. For this, measured sensor data of at least one sensor is input to at least part of the application instances and at least part of the application instances creates and provides control signals for controlling the vehicle based on this data. In particular, the application instances can be operated in an active and at least one passive operation mode. Also, an isolated operation mode can be provided, for example, when a faulty application instance is deactivated. In the active operation mode, the application instance may have direct influence on the control of the vehicle. In the at least one passive operation mode the application instance may run redundantly alongside a similar active application instance, wherein the passive application instance may receive the same input data and creates the same output data or output signals as the active application instance, but without influence on the control of the vehicle. Multiple levels of passive operation modes can be provided. These only differ in the time which is required to switch the passive application instance over to the active operation mode. For example, active and passive application instances are constantly monitored, such that in case a fault in one of the instances is detected countermeasures can be effected, such as changing the configuration.

A configuration may include a mapping of the application instances to individual computation nodes, e.g., which application instance is executed on which computation node. A configuration can also comprise an activation or deactivation of computation nodes and the setting of the operation state. In particular, the configuration can be dependent on predetermined redundancy requirements, which depend on the functionality of the application instances and on the prevailing context. For example, a redundancy requirement can demand a single or multiple redundancy. In this case a given functionality is provided by an active instance and a single or multiple passive application instances. Different application scenarios may be configured with different redundancy requirements, for example, a single redundancy for a pedestrian detection on a motor highway versus a multiple redundancy for a pedestrian detection in a play street.

In some examples, a context may include a description of at least part of the parameters and/or properties which are characteristic of a situation which the vehicle is currently experiencing.

A vehicle is in the examples provided herein may be configured as a motor vehicle. The vehicle can also be another land, water, air, rail or space vehicle.

In some examples, the context information may include at least one fault information, wherein the at least one fault information describes faults occurring in application instances and/or computation nodes. For example, application instances which operate faulty, or which have stopped unexpectedly and/or computation nodes which are faulty or damaged, can be described in such, fault information. The configuration can then be adapted, for example, by adapting the configuration in such a way that the application instances are restarted again, possibly on a different computation node, and/or the faulty computation node is switched off and application instances which have been executed on the faulty computation node are redistributed on the remaining computation nodes.

Part of the gathering device and/or the reconfiguration device can be provided separately or jointly with other devices as a combination of hardware and software, for example, as program code that is executed on a microcontroller or microprocessor.

In one embodiment, provision may be made for the context information to include at least one user context information and/or at least one user request. This allows the configuration to change according to a user state and/or a user action, a user in this example being a passenger of the vehicle. A user context information may include a state of the user of the vehicle, for example a health state, a metabolic state and/or an attention state. A user request, such as a passenger request, may be configured as a request to realize a certain state and/or a certain strategy while driving.

For example, such a strategy can include the shortest possible transportation time and/or the most comfortable and/or energy efficient route etc. Also a user request can include a certain level of amenities provided by the vehicle during the driving, for example, a certain level of entertainment and/or comfort. When the configuration is adapted, the at least one user context information and/or the at least one user request are taken into account.

In one embodiment, provision is made for the context information to include at least one environment information, wherein the at least one environment information is captured by at least one sensor of the vehicle and/or is retrieved by communicating with at least one backend server. An environment information in particular describes a state of the environment. For example, the at least one environment information can include one or more of the following: a season information, a time information (day, night, hour, minute etc.), a weather information (sunny, cloudy, rough, windy, snow, fog, rain etc.), road conditions (paved highway, rural route, gravel street etc.), a scene context information (countryside, rural area, urban environment, small city, big city, industrial park, residential neighborhood etc.). The at least one environment information can be captured by at least one sensor, for example, a camera, a radar sensor, a lidar sensor an ultrasonic sensor and/or a rain sensor etc. Alternatively or in addition, the at least one environment information can be retrieved by communicating, for example, with a cloud service or a backend server which provides weather and/or traffic information etc. For example, the configuration can be adapted as a result of context information which marks a time of day or a daylight status, for example by changing a perception functionality from an application instance that is optimized for night perception to an application instance that is optimized for daytime perception.

In one embodiment, a provision may be made for the context information to include at least one vehicle information. A vehicle information can be captured by at least one sensor of the vehicle and/or can be retrieved from a vehicle control, for example, via a Controller Area Network (CAN)-Bus of the vehicle. A vehicle information can be, for example, a battery state of charge (SOC), a remaining range, power consumption parameters etc. For example, an application instance providing an entertainment functionality can be deactivated, if the vehicle information indicates a battery state of charge that is below a value that is required to complete the requested route etc.

In one embodiment, adapting the configuration may include optimizing the configuration according to at least one optimization criterion. This allows optimization to be performed on the configuration to meet certain ends. Such an optimization criterion can be the following: energy efficiency, a maximum comfort during driving, use of preferred roads and/or routes, minimum and/or preferable redundancy requirements etc.

In some examples, the at least one optimization criterion may be selected and/or defined according to the at least one context information. This allows to automatically select the at least one optimization criterion. In particular, this allows to have an optimal solution to a given scenario, such as a prevailing context. For example, the optimization criterion can be to extend the range to complete a planned route without a recharge or refill, if a vehicle information indicates a low battery or a low fuel level.

In one embodiment, adapting the configuration includes selecting and/or defining application instance requirements according to the at least one gathered context information. The application instance requirements may include CPU and memory demands.

The application instance requirements may be defined by using implication rules which are specified and applied using a declarative programming language. This allows to easily express and/or code the implication rules.

In one embodiment, adapting the configuration includes selecting a set of application instances according to the at least one gathered context information and/or determining redundancy requirements of the application instances according to the at least one gathered context information and/or determining hardware and/or software segregation requirements of the application instances according to the at least one gathered context information. Hardware segregation in particular defines the number of different computation nodes redundant application instances have to be executed on. Software segregation in particular defines the number of different (types of) operation systems the application instances have to be executed on.

In one embodiment, adapting the configuration includes optimally assigning application instances to the computation nodes.

The assigning may include applying at least one of the following methods to find the optimal assignment: integer linear programming, evolutionary game theory, reinforcement learning.

In one embodiment, adapting the configuration may include safety validation of the adapted configuration. For example, the safety validation may be conducted before the adapted configuration is assigned to the computation nodes, i.e., before it is activated. The safety validation may include checking, if all redundancy requirements and software and hardware segregation requirements are met.

In one embodiment, the method may be constantly repeated such that the configuration is continuously adapted according to the prevailing context. This allows to constantly have a configuration that is adapted to the prevailing situation and requests of the passengers of the vehicle. Hence comfort and safety can be ensured.

The individual embodiments of the device in each case correspond to the embodiments of the methods disclosed herein. The advantages of the device are in each case the same as for the embodiments of the method.

Further, also a vehicle is disclosed that includes at least one device according to any one of the described embodiments.

### BRIEF DESCRIPTION OF THE DRAWINGS

The present disclosure is explained in greater detail below on the basis of preferred exemplary embodiments with reference to the drawings. In the drawings:

FIG. 1 shows an embodiment of the device for configuring a system architecture of an autonomous vehicle under certain aspects of the present disclosure;

FIG. 2 shows a schematic overview of an embodiment of the method, wherein three logical layer are used under certain aspects of the present disclosure.

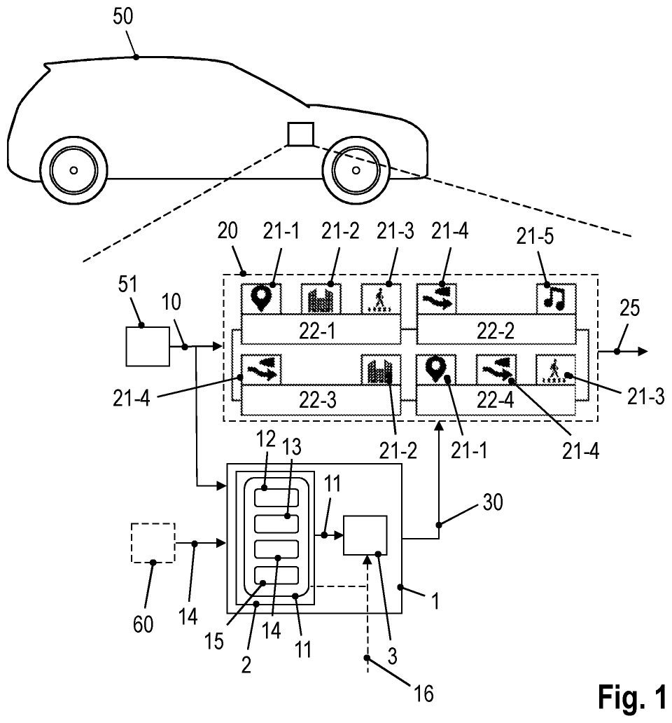

FIG. 1 shows an embodiment of the device 1 for configuring a system architecture of an autonomous vehicle under certain aspects of the present disclosure.

### DETAILED DESCRIPTION

Turning to FIG. 1, the system architecture 20 of the autonomous vehicle 50 includes a plurality of application instances 21-x and a plurality of computation nodes 22-x, wherein the application instances 21-x are distributed and executed on the computation nodes 22-x according to a configuration 30. Measured sensor data 10 of at least one sensor 51 is input to at least part of the application instances 21-x and at least part of the application instances 21-x creates and provides control signals 25 for controlling the vehicle 50.

For example, the application instances 21-x can provide the following functionalities: navigation (21-1), object detection in an urban environment (21-2), pedestrian detection (21-3), trajectory planner (21-4), and audio entertainment (21-5). Security relevant application instances 21-x are executed redundantly on multiple computation nodes 22-x (for example, application instances 21-3, 21-4).

The device 1 includes a gathering device 2 and a reconfiguration device 3. The gathering device 2 and the reconfiguration device 3 can be provided separately or jointly with other devices as a combination of hardware and software, for example, as program code that is executed on a microcontroller or microprocessor.

The gathering device 2 may gather at least one context information 11 of a prevailing context. The gathered at least one context information 11 is delivered to the reconfiguration device 3. The context information 11 may comprise at least one user context information 12 and/or one user request 13.

The context information 11 may include at least one environment information 14, wherein the at least one environment information 14 is captured by at least one sensor 51 of the vehicle and/or is retrieved by communicating with at least one backend server 60.

The context information 11 may include at least one vehicle information 15. For example, a vehicle information 15 can be a state-of-charge (SOC) of a vehicle battery or a remaining range of the vehicle. The at least one vehicle information 15 can be retrieved, for example, from a control of the vehicle via a Controller Area Network (CAN)-bus.

The reconfiguration device 3 may adapt the configuration 30 of the application instances 21-x according to the at least one gathered context information 11. This allows the ability to adapt the configuration 30, e.g., the mapping of the application instances 21-x, to the computation nodes 22-x, according to a prevailing context, such that the system architecture 20 can best handle the current situation and safety is ensured.

In some examples, the method may be constantly repeated such that the configuration 30 is continuously adapted according to the prevailing context.

The adapting of the configuration 30 may include optimizing the configuration 30 according to at least one optimization criterion 16. The optimization criterion 16 may be set by a user, e.g., a passenger, operator and/or owner of the vehicle 50. The optimization may be performed by the reconfiguration device 3. An optimization criterion 16 can be, for example, energy efficiency, comfort, transportation time etc.

The at least one optimization criterion 16 may be selected and/or defined according to the at least one context information 11. This allows to change to at least one optimization criterion 16 which may lead to an optimal configuration 30 for the prevailing context and situation.

Adapting the configuration 30 may include selecting and/or defining application instance requirements according to the at least one gathered context information 11. The application instance requirements may be configured to define a set of application instances 21-x which are necessary to handle the prevailing context.

The application instance requirements may be defined by using implication rules that are specified and applied using a declarative programming language. Hence a reasoning as to which application instances 21-x may be necessary and/or preferable under given circumstances can be realized.

Adapting the configuration 30 may include selecting a set of application instances 21-x according to the at least one gathered context information 11 and/or determining redundancy requirements of the application instances 21-x according to the at least one gathered context information 11 and/or determining hardware and/or software segregation requirements of the application instances 21-x according to the at least one gathered context information 11. This way a “tailor-made” configuration 30 for a prevailing context can be provided.

Adapting the configuration 30 may include optimally assigning application instances 21-x to the computation nodes 22-x. For example, an assignment which satisfies the requirements demanded from the adapted configuration 30 may be selected. If more than one solution exists to this assignment problem, a further optimization can be performed. The assigning can be solved by methods which include, for example, integer linear programming, evolutionary game theory, or reinforcement learning.

In some examples, adapting the configuration 30 includes safety validation of the adapted configuration 30 before the assignment is executed. The safety validation may include a verification that redundancy requirements and/or software and hardware segregation requirements can be met by the adapted configuration 30.

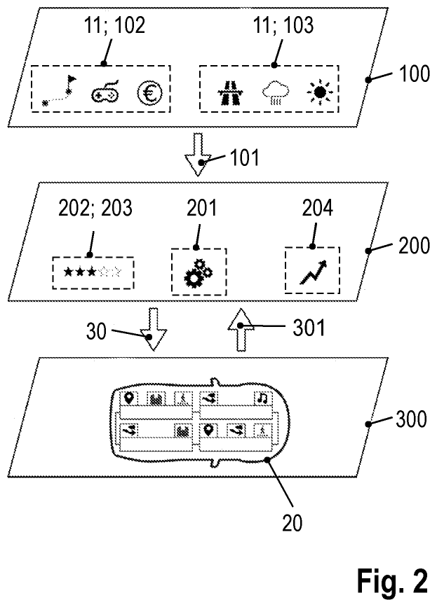

FIG. 2 shows a schematic overview of an embodiment of a method, wherein three logical layer are used in the example: a context layer 100, a reconfiguration layer 200, and an architecture layer 300. The functions of the layers 100, 200, 300 may be executed by the gathering device and the reconfiguration device or, alternatively, by a combined device.

The context layer 100 determines the prevailing context the vehicle is in, by gathering at least one context information 11. Further, it extracts requirements 101 affecting the actions of the layers 200, 300. Mission goals 102, such as a target destination, a requested level of entertainment, or the road and/or ride type paid for, as well as environmental conditions, such as the current weather situation and/or the road and/or traffic conditions are examples for parameters influencing the decision regarding the requirements in the form of context information 11.

In some examples, the context may be the following: A premium ride on a highway in wintry condition. These context information imply, for example, that the set of required applications (possibly provided by single or multiple application instances) include a pedestrian detection, a trajectory planner which takes rough weather conditions into account, and an entertainment application.

In another example, the context may be the following: A low-budget ride is operative in an urban environment, under good weather conditions. These context information 11 imply, that the set of required applications (possibly provided by single or multiple application instances) include a pedestrian detection, a trajectory planner which takes the good weather conditions into account, and an application for computing tasks received from cloud services.

The examples above are simplified, and are provided for illustrative purposes only. Those skilled in the art will recognize that more extensive and demanding configurations are contemplated in the present disclosure.

Also, the safety-criticality of the respective applications can be derived from the context information 11, and thus requirements 101 for the level of redundancy, as well as other performance parameters can be derived.

As an illustrative example, the level of redundancy of the pedestrian detection in the first example can be much lower than in the second example, since the likelihood of encountering a pedestrian on a highway is much lower than in an urban environment.

In some examples, the context information 11 can be derived from sensor data captured by at least one sensor of the vehicle and/or by communicating with a backend server and/or by interacting with the passengers of the vehicle.

The application instance requirements 101 may be defined by using implication rules that are specified and applied using a declarative programming language.

The requirements 101 determined by the context layer 100 may be used as input for the reconfiguration layer 200. The reconfiguration layer 200 evaluates the received requirements 101 and plans further actions considering the prevailing context. These actions may include, for example, selecting a set of applications, determining their redundancy and software and hardware segregation requirements as well as optimizing the entire system architecture. The reconfiguration layer performs the reconfiguration computation 201.

The task of determining a context-based adapted configuration 30, such as a mapping between application instances and computation nodes that respects the prevailing context, is not trivial since the placement decisions depend on various parameters.

The input of this “application placement problem” is a set of application instances and a set of computation nodes. Furthermore, for each application instance and each computation node a set of parameters including, for example, performance parameters 202 such as the minimum required memory and CPU demand as well as safety parameters 203 like the minimum required level of redundancy and hardware segregation may be defined. The output of the application placement problem is a configuration 30 in the form of an assignment that maps each application instance to exactly one node.

In order to restrict the number of valid assignments, constraints based on the specified parameters can be defined. Depending on the specified constraints, either none, one, or multiple valid assignments may be configured. In case that there are different solutions, an optimization function 204 in consideration of at least one optimization criterion can be defined that specifies which assignments are the most desired.

This optimization function 204 may also depend on the prevailing context. Therefore, an approach allowing a context-based update of the at least one optimization criterion leads to configurations that are well adjusted to a current situation.

For solving the “application placement problem”, various optimization approaches can be used, for example, integer linear programming, evolutionary game theory, or reinforcement learning approaches.

The architecture layer 300 executes the tasks responsible for interacting with the system architecture of the vehicle, such as the application instances and computation nodes. One main task of the architecture layer 300 may be to apply the reconfiguration actions determined by the reconfiguration layer 200.

A challenge during operation may be to ensure a fast, safe, and organized configuration roll-out. Furthermore, it has always to be ensured that the reconfiguration actions do not decrease the level of safety. Therefore, safety-validation operations should be executed prior to the configuration roll-out.

Besides applying reconfiguration actions, such as applying the adapted configuration 30, monitoring the state of the computation nodes and the executed application instances may be an important task. Self-awareness requires monitoring the status of the system to maintain an operational state. The application instances, for example, may be configured to assess their current performance and report faults. Monitoring the system, in turn, depends in general on the observation of several level-specific data.

Concerning safety, different levels may define different requirements for a minimum operational capability. Since full vehicle autonomy may exclude human takeover actions, classical fault tolerance may not be sufficient, as errors may have various causes and interference effects. Failure handling requires knowledge of cross-layer dependencies. Thus, system monitoring and self-awareness are cross-layer problems, such that system changes 301 are reported back to the reconfiguration layer 200, such that they can affect the adapting of the configuration 30.

### LIST OF REFERENCE NUMERALS

1 device

2 context gathering device

3 reconfiguration device

10 measured sensor data

11 context information

12 user context information

13 user request

14 environment information

15 vehicle information

16 optimization criterion

20 system architecture

21-x application instance

22-x computation node

25 control signal

30 configuration

50 vehicle

51 sensor

60 backend server

100 context layer

101 requirement

200 reconfiguration layer

201 reconfiguration computation

202 performance parameters

203 safety parameters

204 optimization function

300 architecture layer

301 system changes

1-15. (canceled).

16. A method for operating a system architecture of an autonomous vehicle, comprising:
inputting vehicle sensor data to at least a portion of a plurality of application instances distributed and executed across a plurality of computational nodes of the autonomous vehicle according to a configuration;
generating control signals via at least the portion of the plurality of application instances to control the autonomous vehicle;
gathering at least one context information of a current context; and
adapting the configuration according to the gathered context information.

17. The method of claim 16, wherein the context information comprises at least one vehicle user context information and/or one vehicle user request.

18. The method of claim 16, wherein the context information comprises environment information, wherein the environment information is captured by at least one sensor of the vehicle and/or is received by communicating with at least one backend server.

19. The method of claim 16, wherein the context information comprises vehicle information.

20. The method of claim 16, wherein adapting the configuration comprises optimizing the configuration according to at least one optimization criterion.

21. The method of claim 20, wherein the at least one optimization criterion is selected and/or defined according to the at least one context information

22. The method of claim 16, wherein adapting the configuration comprises selecting and/or defining application instance requirements according to the at least one gathered context information.

23. The method of claim 16, further comprising defining application instance requirements by using implication rules that are specified and applied using a declarative programming language.

24. The method of claim 16, wherein adapting the configuration comprises at least one of:
selecting a set of application instances according to the at least one gathered context information;
determining redundancy requirements of the application instances according to the at least one gathered context information; and/or
determining hardware and/or software segregation requirements of the application instances according to the at least one gathered context information.

25. The method of claim 16, wherein adapting the configuration comprises optimally assigning application instances to the computation nodes.

26. The method of claim 25, wherein the assigning comprises applying at least one of integer linear programming, evolutionary game theory, and reinforcement learning to determine the optimal assignment.

27. The method of claim 16, wherein adapting the configuration comprises establishing safety validation of the adapted configuration.

28. The method of claim 16, further comprising repeating the inputting, generating, gathering, and adapting such that the configuration is repeatedly adapted according to the current context.

29. A system for operating a system architecture of an autonomous vehicle, comprising:
one or more sensors for producing sensor data;
a context gathering device configured to gather context information of a current context of the autonomous vehicle;
a reconfiguration device; and
a memory for storing a configuration for the autonomous vehicle, wherein the context gathering device, the reconfiguration device, and the memory are configured to
input the vehicle sensor data to at least a portion of a plurality of application instances distributed and executed across a plurality of computational nodes of the autonomous vehicle according to the configuration;
generate control signals via at least the portion of the plurality of application instances to control the autonomous vehicle;
gather at least one context information of a current context; and
adapt the configuration according to the gathered context information.

30. The system of claim 29, wherein the context information comprises at least one of
(i) vehicle user context information;
(ii) a vehicle user request;
(iii) environment information captured by the one or more sensors;
(iv) environment information received by communicating with at least one backend server; and
(v) vehicle information.

31. The system of claim 29, wherein adapting the configuration comprises at least one of
optimizing the configuration according to at least one optimization criterion, selected and/or defined according to the at least one context information; and/or
selecting and/or defining application instance requirements according to the at least one gathered context information.

32. The system of claim 29, wherein the context gathering device, the reconfiguration device, and the memory are configured to define application instance requirements by using implication rules that are specified and applied using a declarative programming language.

33. The method of claim 16, wherein the context gathering device, the reconfiguration device, and the memory are configured to adapt the configuration by at least one of:
selecting a set of application instances according to the at least one gathered context information;
determining redundancy requirements of the application instances according to the at least one gathered context information;
determining hardware and/or software segregation requirements of the application instances according to the at least one gathered context information; and/or
optimally assigning application instances to the computation nodes, wherein the assigning comprises applying at least one of integer linear programming, evolutionary game theory, and reinforcement learning to determine the optimal assignment.

34. A method for operating a system architecture of an autonomous vehicle, comprising:
inputting vehicle sensor data to at least a portion of a plurality of application instances distributed and executed across a plurality of computational nodes of the autonomous vehicle according to a configuration;
generating control signals via at least the portion of the plurality of application instances to control the autonomous vehicle;
gathering at least one context information of a current context; and
adapting the configuration according to the gathered context information, wherein adapting the configuration comprises optimizing the configuration according to at least one optimization criterion determined from the at least one context information
